(19) United States
(12) Patent Application Publication
(10) Pub. No.: US 2025/0347909 A1
(43) Pub. Date: Nov. 13, 2025

(54) IMAGING APPARATUS

(71) Applicant: i-PRO Co., Ltd., Tokyo (JP)

(72) Inventors: Yohei KOYANAGI, Tokyo (JP); Haruaki MORI, Tokyo (JP)

(73) Assignee: i-PRO Co., Ltd., Tokyo (JP)

(21) Appl. No.: 19/188,595

(22) Filed: Apr. 24, 2025

(30) Foreign Application Priority Data
May 10, 2024 (JP) 2024-077337

(51) Int. Cl. G02B 27/00; G03B 17/08

(52) U.S. Cl. CPC G02B 27/0006; G03B 17/08

(57) ABSTRACT

The imaging apparatus includes an imaging unit configured to image a subject, a cover member including a spherical portion that is light transmissive, the spherical portion covering the imaging unit, an exterior member to which the cover member is fixed on an inner surface side and in which an opening through which the spherical portion protrudes toward an outer surface side is formed, and a packing interposed between the cover member and the exterior member, wherein the exterior member includes a ring-shaped inner circumferential surface forming the opening, the inner circumferential surface being at a predetermined interval from an outer surface of the spherical portion, and the packing includes a ring-shaped dirt prevention portion sandwiched between the outer surface of the spherical portion and the inner circumferential surface of the exterior member and elastically compressed.

### CROSS REFERENCE TO RELATED APPLICATIONS

This application claims the benefit of priority to Japanese Patent Application Number 2024-077337 filed on May 10, 2024. The entire contents of the above-identified application are hereby incorporated by reference.

### TECHNICAL FIELD

The present disclosure relates to an imaging apparatus.

### BACKGROUND

JP 2020-98301 A discloses an imaging apparatus including a cover member. The cover member includes a spherical portion covering an imaging unit. A packing for preventing water from entering is provided between the cover member and an exterior member. An imaging apparatus including such a cover member is used as, for example, a surveillance camera installed at a ceiling, a wall, or the like of a building.

### SUMMARY

However, in the imaging apparatus described in JP 2020-98301 A, the packing is interposed between a part of the cover member extending outward relative to the spherical portion and the exterior member. Therefore, there is a clearance between the spherical portion and the exterior member, and foreign matter such as dirt may enter the clearance. When foreign matter remains in such a clearance, it is unhygienic and not preferable in terms of appearance. Therefore, when it is desired to remove foreign matter entering the clearance, the cover member and the exterior member need to be removed for cleaning. In particular, when the imaging apparatus is used as a surveillance camera, it is difficult to frequently remove the cover member and the exterior member, and it takes time and effort for cleaning.

An object of the present disclosure is to provide an imaging apparatus capable of improving cleanability.

In order to achieve the above object, an imaging apparatus according to the present disclosure includes an imaging unit configured to image a subject, a cover member including a spherical portion that is light transmissive, the spherical portion covering the imaging unit, an exterior member to which the cover member is fixed on an inner surface side and in which an opening through which the spherical portion protrudes toward an outer surface side is formed, and a packing interposed between the cover member and the exterior member, wherein the exterior member includes a ring-shaped inner circumferential surface forming the opening, the inner circumferential surface being at a predetermined interval from an outer surface of the spherical portion, and the packing includes a ring-shaped dirt prevention portion sandwiched between the outer surface of the spherical portion and the inner circumferential surface of the exterior member and elastically compressed.

The present disclosure can improve cleanability.

### BRIEF DESCRIPTION OF DRAWINGS

FIG. 1 is an external perspective view of a state in which a surveillance camera according to an embodiment is installed at a ceiling and walls.

FIG. 2 is a perspective view of the surveillance camera.

FIG. 3 is an exploded perspective view of the surveillance camera.

FIG. 4 is a front view of the surveillance camera.

FIG. 5 is a bottom view of the surveillance camera.

FIG. 6 is a side view of the surveillance camera.

FIG. 7 is a vertical cross-sectional view of main parts of the surveillance camera.

FIG. 8 is an exploded perspective view of an exterior unit.

FIG. 9 is an exploded perspective view of the exterior unit viewed from a base end side.

FIG. 10 is a vertical cross-sectional view of main parts of a cover member, an exterior member, and a packing.

FIG. 11 is an explanatory view illustrating a dimensional relationship between a clearance between the cover member and the exterior member, and the packing.

FIG. 12 is an explanatory view for describing a change in the shape of the packing sandwiched between the cover member and the exterior member and elastically compressed.

### DESCRIPTION OF EMBODIMENTS

Hereinafter, an embodiment of the disclosure will be described with reference to the drawings. The present embodiment achieves a very versatile imaging apparatus, thereby contributing to “9. Industry, innovation and infrastructure” of Sustainable Development Goals (SDGs) proposed by the United Nations.

### Overall Configuration of Surveillance Camera 1

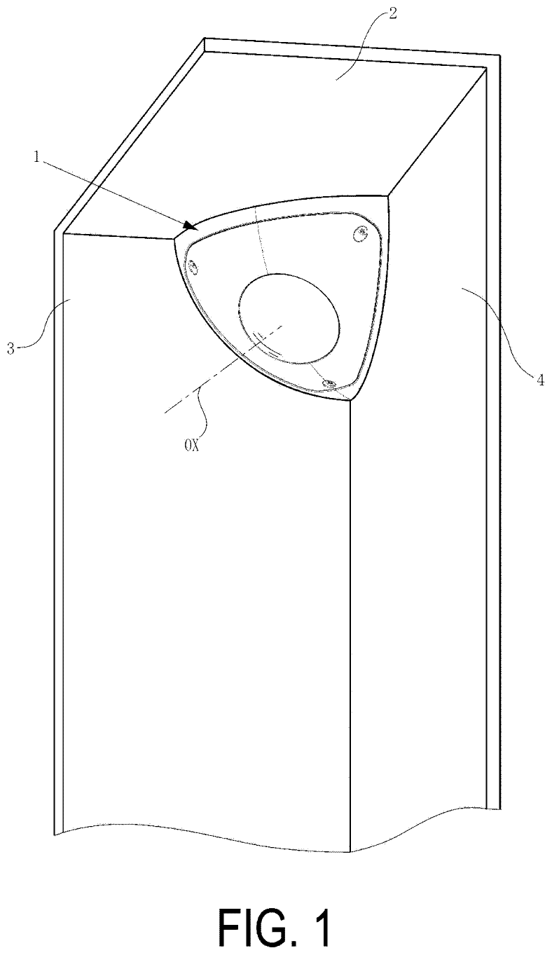

Hereinafter, a surveillance camera that is an aspect of an imaging apparatus according to the embodiment of the present disclosure will be described. As illustrated in FIG. 1, the surveillance camera 1 is installed at a corner portion formed by, for example, a ceiling 2 and two walls 3 and 4 in contact with the ceiling 2 and thus is also referred to as a corner camera. Typically, the surveillance camera 1 is installed at the corner portion formed between the ceiling 2 and the walls 3 and 4 orthogonal to each other.

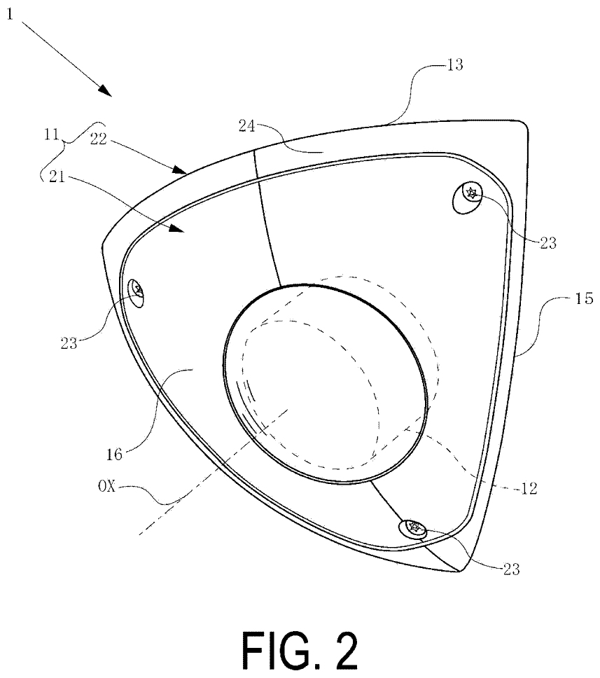

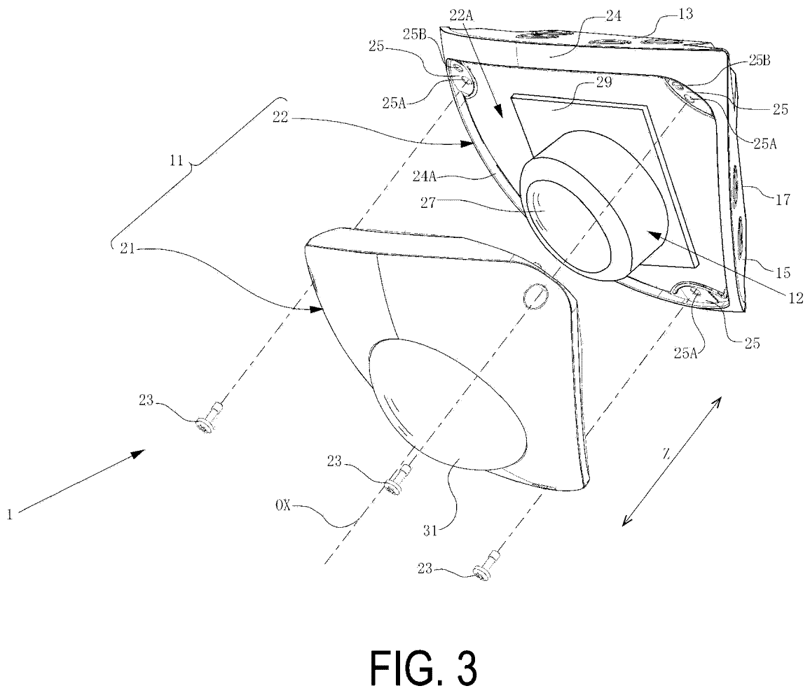

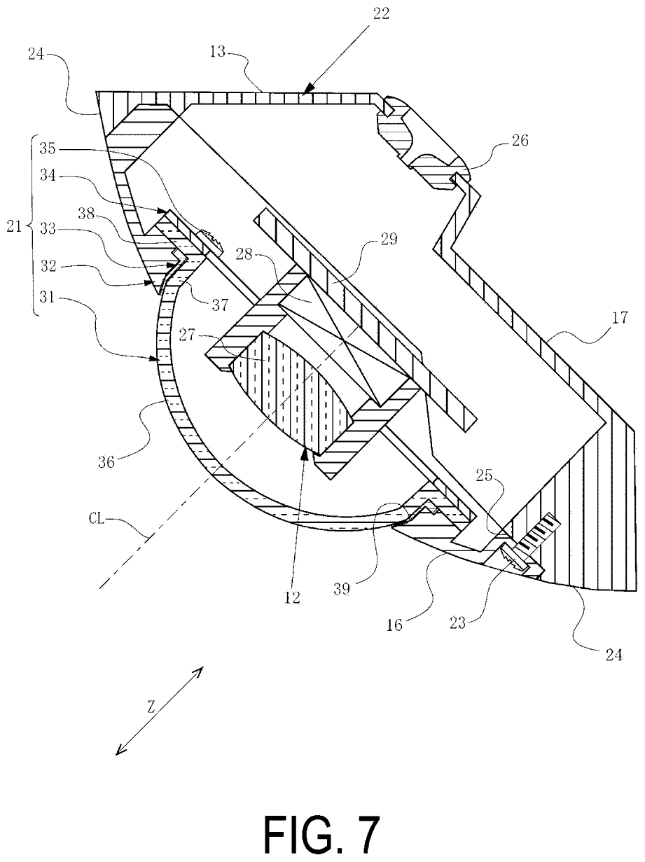

As illustrated in FIGS. 2 and 3, the surveillance camera 1 includes a housing 11 and an imaging unit 12. The housing 11 is a portion accommodating the imaging unit 12 and attached to the ceiling 2 and the walls 3 and 4. The imaging unit 12 images a subject around the surveillance camera 1 and outputs imaging data (for example, still image data or video data). For example, as illustrated in FIG. 7, the imaging unit 12 includes a lens 27, an imaging element 28, and a circuit board 29. The lens 27 and the imaging element 28 are mounted at the circuit board 29. The circuit board 29 is fixed to a housing main body 22. The lens 27 is directed obliquely downward, for example. That is, the imaging unit 12 images a subject located obliquely downward.

Hereinafter, the imaging direction of the imaging unit 12 (more specifically, a direction toward the center of the angle of view of the imaging unit 12) is referred to as an optical axis OX of the imaging unit 12. The optical axis OX of the imaging unit 12 is a straight line extending obliquely downward when the surveillance camera 1 is installed at the corner portion. In addition, the optical axis OX may coincide with a central axis CL of an opening 39 of an exterior member 32 described below. Further, a direction parallel to the central axis CL is defined as an “axial direction Z”, a direction orthogonal to the central axis CL is defined as a “radial direction R”, and a direction of a circumference of a circle centered on the axial direction Z is defined as a “circumferential direction”. In addition, in the axial direction Z, a side from the imaging unit 12 toward the subject is defined as a “distal end side”, and an opposite side thereof is defined as a “base end side”. In the radial direction R, a side closer to the central axis CL is defined as an “inner side in the radial direction R”, and a side away from the central axis CL is defined as an “outer side in the radial direction R”.

### Configuration of Housing 11

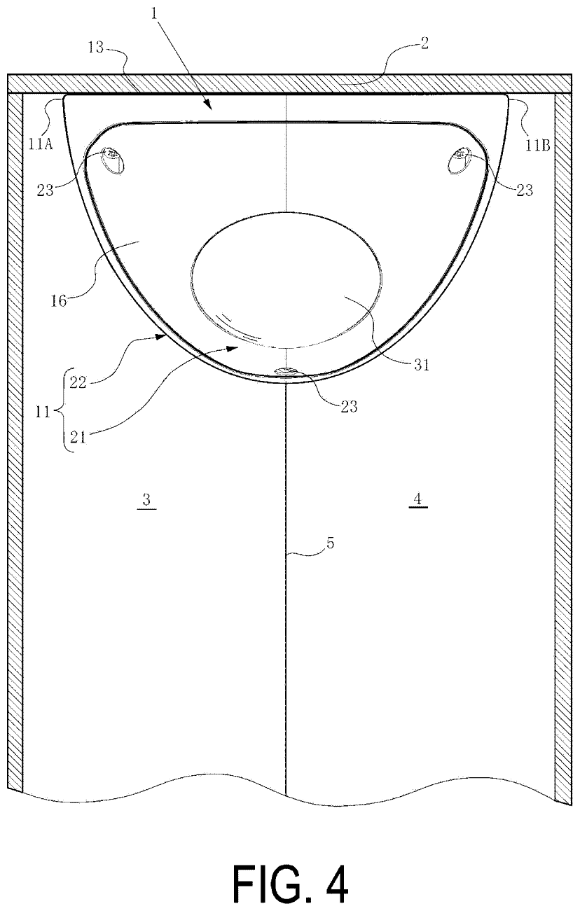

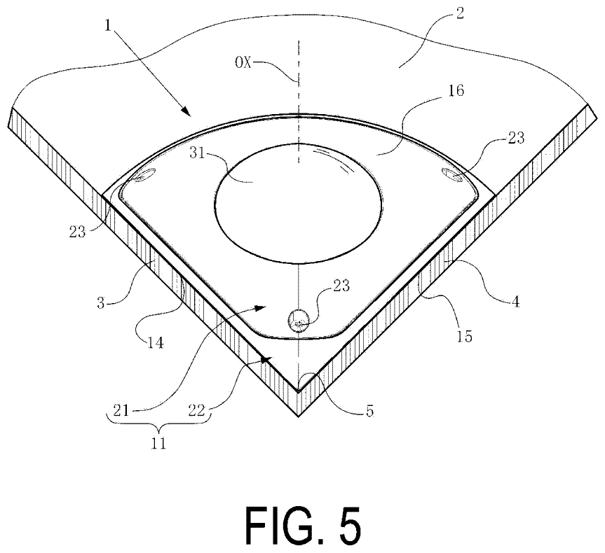

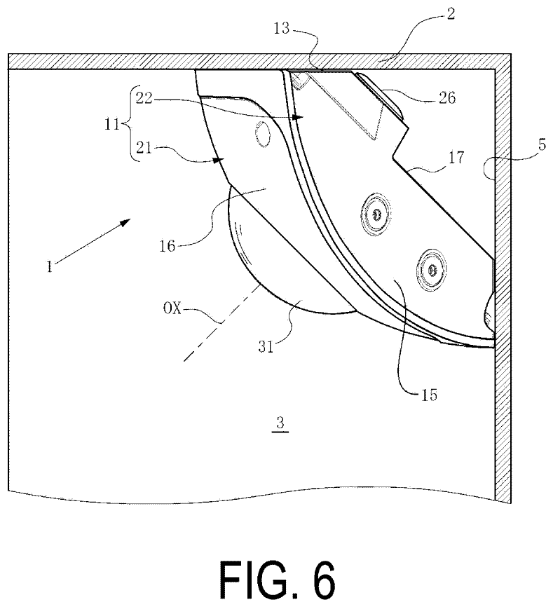

As illustrated in FIGS. 4 to 6, the outer surfaces of the housing 11 include a top surface 13, side surfaces 14 and 15, a curved surface 16, and a back surface 17. The top surface 13 is attached to the ceiling 2, and the side surfaces 14 and 15 are attached to the walls 3 and 4, so that the housing 11 is fixed to the corner portion. The top surface 13 and the side surfaces 14 and 15 are flat surfaces orthogonal to each other. The curved surface 16 is a convex curved surface that is convex toward the distal end side in the axial direction Z. The curved surface 16 constitutes, for example, a part of an outer circumferential surface of a sphere. The curved surface 16 is a convex curved surface that is convex obliquely downward when the surveillance camera 1 is installed at the corner portion. The back surface 17 is a surface on a side opposite to the curved surface 16 in the axial direction Z with the imaging unit 12 interposed therebetween. A grommet 26 for drawing out a harness extending from the imaging unit 12 is provided at the back surface 17.

The housing 11 includes an exterior unit 21 and the housing main body 22. The exterior unit 21 and the housing main body 22 are fastened with screws 23 to form an internal space for accommodating the imaging unit 12. The housing main body 22 includes the top surface 13, the side surfaces 14 and 15, a part of the curved surface 16, and the back surface 17. The exterior unit 21 includes the other part of the curved surface 16. That is, the housing main body 22 is fixed to a fixation target surface such as a ceiling or a wall with a fastener such as a bolt. The housing main body 22 supports the imaging unit 12. On the other hand, the exterior unit 21 is supported by the housing main body 22 on the distal end side in the axial direction Z relative to the imaging unit 12. Further, the housing 11 (surveillance camera 1) has a substantially triangular outer shape in a plan view from the distal end side in the axial direction Z.

### Configuration of Housing Main Body 22

The side surfaces 14 and 15 extend toward the distal end side in the axial direction Z relative to the back surface 17. The housing main body 22 includes an internal space 22A (see FIG. 3) surrounded by the back surface 17, the side surfaces 14 and 15, and the top surface 13. The top surface 13 and the side surfaces 14 and 15 are arranged in a triangular shape. As illustrated in FIGS. 2 and 3, the housing main body 22 includes an outer peripheral edge portion 24 that is a surface extending inward in the radial direction R from end portions of the top surface 13 and the side surfaces 14 and 15 on the distal end side in the axial direction Z. The outer peripheral edge portion 24 is formed over the entire periphery of the end portions of the top surface 13 and the side surfaces 14 and 15 on the distal end side in the axial direction Z. The outer peripheral edge portion 24 constitutes a part of the curved surface 16.

In addition, an inner peripheral surface 24A is formed at the housing main body 22. The inner peripheral surface 24A extends from an end portion of the outer peripheral edge portion 24 on the inner side in the radial direction R to the base end side in the axial direction Z toward the back surface 17. Furthermore, a plurality of attachment surfaces 25 are formed at the housing main body 22. The plurality of attachment surfaces 25 are surfaces extending inward in the radial direction R from an end portion of the inner peripheral surface 24A on the base end side. The attachment surfaces 25 are surfaces orthogonal to the axial direction Z. Note that, regarding the exterior unit 21, the housing main body 22, a below-described cover member 31, and a below-described exterior member 32, the internal space 22A side of the housing main body 22 will be defined below as an inner side, and the outer side of the housing main body 22 will be defined below as an outer side.

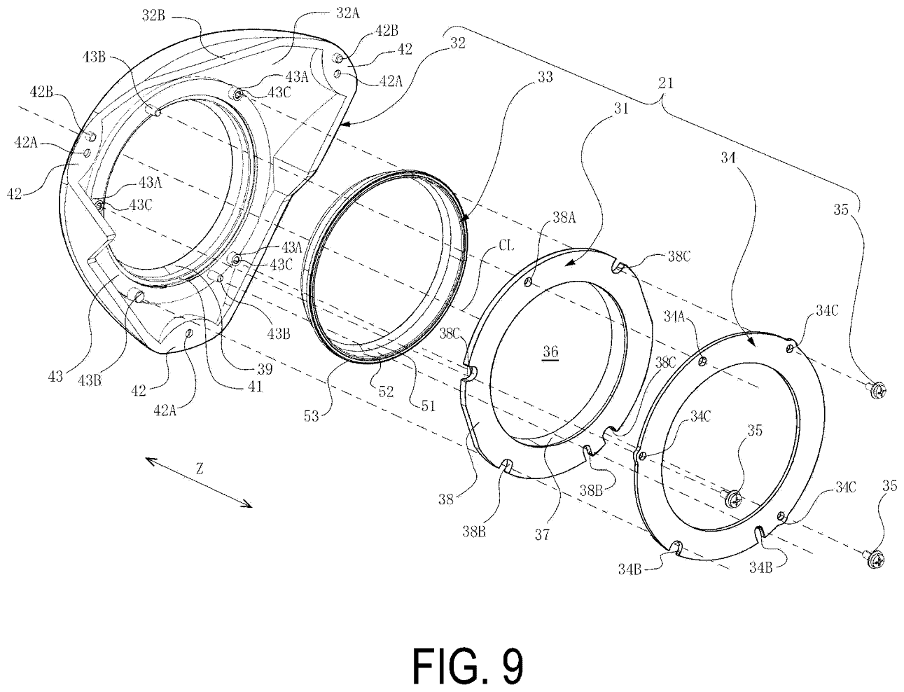

One or both of a female screw hole 25A and a positioning hole 25B are formed in each attachment surface 25. The attachment surfaces 25 are located at positions adjacent to two of the top surface 13 and the side surfaces 14 and 15, that is, at vertexes of a triangle formed by the side surfaces 14 and 15 and the top surface 13. The positioning hole 25B is formed in each attachment surface 25 adjacent to the top surface 13 among the vertexes of the above-described triangle. Therefore, the positioning holes 25B are formed at two positions. The female screw hole 25A and the positioning hole 25B extend toward the base end side in the axial direction Z. Screws 23 inserted through through holes 42A (see FIG. 9) of the exterior unit 21 described below are screwed into the female screw holes 25A. Thus, the exterior unit 21 is fastened to the housing main body 22. Positioning pins 42B (see FIG. 9) of the exterior unit 21 are inserted into the positioning holes 25B. Thus, the exterior unit 21 is positioned with respect to the housing main body 22.

### Configuration of Exterior Unit 21

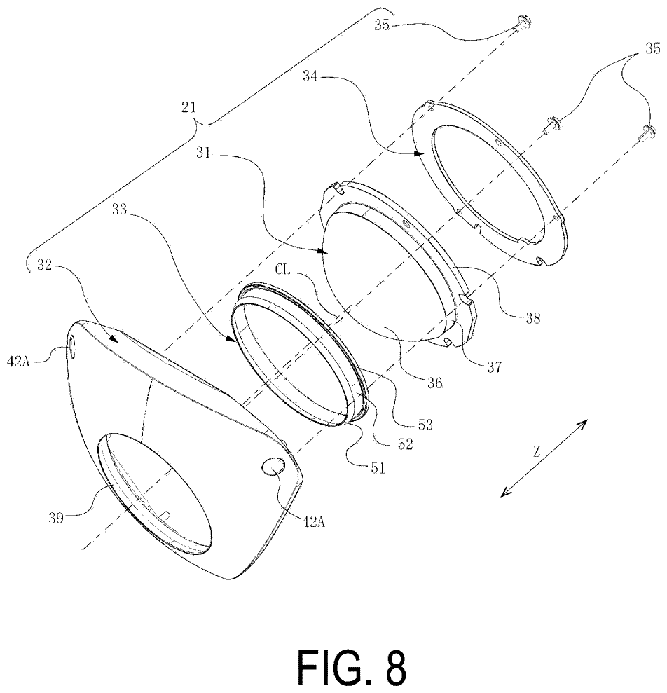

As illustrated in FIGS. 7 and 8, the exterior unit 21 includes the cover member 31, the exterior member 32, a packing 33, a fixing member 34, and screws 35. The exterior unit 21 is obtained by forming the components (31 to 35) as a unit, fitted inside the outer peripheral edge portion 24 in the radial direction R, and fixed to the attachment surfaces 25 of the housing main body 22. In addition, the exterior unit 21 covers the imaging unit 12 on the distal end side in the axial direction Z relative to the imaging unit 12.

The cover member 31 is a member that protects the imaging unit 12 and that allows external light to be incident on the imaging unit 12. The cover member 31 includes a spherical portion 36, an intermediate portion 37, and a flange portion 38. The cover member 31 (at least the spherical portion 36) has a light transmissive property that allows visible light to pass therethrough. The cover member 31 is integrally molded of resin, for example.

The spherical portion 36 constitutes a part of a hollow sphere. More specifically, the spherical portion 36 has a so-called “spherical segment shape” obtained by cutting a sphere along a single plane. Further, the spherical portion 36 may have a so-called “hemispherical shape” obtained by cutting a sphere along a plane including the center. Further, the outer surface of the spherical portion 36 is a spherical surface (curved surface). Further, at least a part of the imaging unit 12 is accommodated inside the spherical portion 36. Hereinafter, an end portion of the spherical portion on the base end side in the axial direction Z is referred to as an “end portion”.

The intermediate portion 37 has a cylindrical outer shape. The intermediate portion 37 extends in the axial direction Z. Further, one end (distal end side) of the intermediate portion 37 in the axial direction Z is connected to the end portion of the spherical portion 36, and another end (base end side) of the intermediate portion 37 in the axial direction Z is connected to an inner circumferential side of the flange portion 38. That is, the intermediate portion 37 is a portion located between the spherical portion 36 and the flange portion 38 and connecting the spherical portion 36 and the flange portion 38. In other words, the spherical portion 36 and the flange portion 38 are located on opposite sides with the intermediate portion 37 interposed therebetween. In still other words, the spherical portion 36 and the flange portion 38 are spaced apart with the intermediate portion 37 interposed therebetween.

The flange portion 38 is a surface that protrudes outward in the radial direction R from the other end of the intermediate portion 37 relative to the spherical portion 36 and that is continuous in the circumferential direction. The flange portion 38 is a ring-shaped portion centered on the central axis CL. As illustrated in FIG. 9, a positioning hole 38A, positioning grooves 38B, and cutouts 38C are formed in the flange portion 38.

The positioning hole 38A is a through hole that penetrates the flange portion 38 in the axial direction Z. The positioning grooves 38B are grooves extending toward the central axis CL from an outer edge of the flange portion 38, which is an outer end of the flange portion 38 in the radial direction R. Positioning pins 43B of the exterior member 32 described below enter the positioning hole 38A and the positioning grooves 38B. The cutouts 38C are grooves extending from the outer edge of the flange portion 38 toward the central axis CL. The cutouts 38C receive bosses 43A of the exterior member 32 described below.

### Configuration of Exterior Member 32

The cover member 31 is fixed to the inner surface side of the exterior member 32. The opening 39 through which a part of the spherical portion 36 protrudes toward the outer surface side is formed in the exterior member 32. Furthermore, the exterior member 32 is attached to the housing main body 22. The outer surface side of the exterior member 32 coincides with the distal end side in the axial direction Z, and the inner surface side of the exterior member 32 coincides with the base end side in the axial direction Z.

For example, as illustrated in FIG. 9, the exterior member 32 includes a main wall 32A and a tubular wall 32B. The main wall 32A has a plate shape. Further, the tubular wall 32B including an outer surface constituting the curved surface 16 of the housing 11 protrudes from the outer edge of the main wall 32A toward the base end side in the axial direction Z. Further, the tubular wall 32B is continuous in the circumferential direction along the outer edge of the main wall 32A. When the exterior unit 21 and the housing main body 22 are combined, the outer surface of the main wall 32A is continuous with the outer surface of the outer peripheral edge portion 24 of the housing main body 22, so that the curved surface 16 is formed. The tubular wall 32B is disposed on the inner side of the housing main body 22 relative to the outer peripheral edge portion 24.

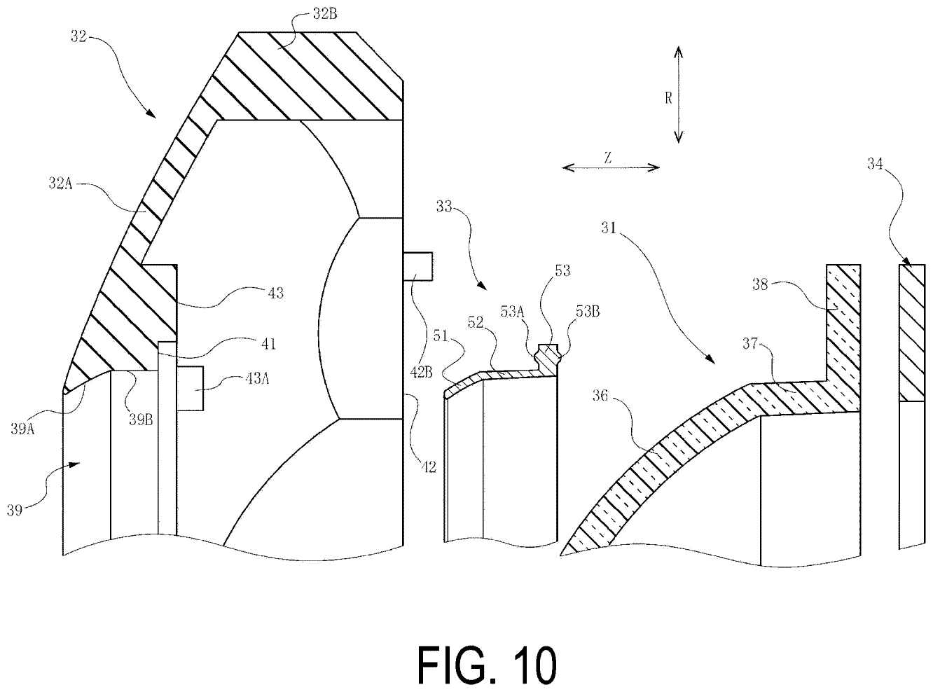

The opening 39 penetrates the center of the main wall 32A in the axial direction Z. As illustrated in FIG. 10, the opening 39 is defined by a first inner circumferential surface 39A and a second inner circumferential surface 39B. Each of the first inner circumferential surface 39A and the second inner circumferential surface 39B is a ring-shaped surface centered on the central axis CL. The first inner circumferential surface 39A and the second inner circumferential surface 39B are surfaces disposed at a predetermined interval from the outer surface of the spherical portion 36. Furthermore, the first inner circumferential surface 39A and the second inner circumferential surface 39B are surfaces adjacent to each other in the axial direction Z.

The first inner circumferential surface 39A is located on the distal end side in the axial direction Z relative to the second inner circumferential surface 39B. The first inner circumferential surface 39A is a curved surface (spherical surface) that is curved so as to gradually decrease the diameter of the opening 39 toward the distal end side in the axial direction Z. In other words, the first inner circumferential surface 39A is a curved surface along the outer surface of the spherical portion 36. In still other words, the first inner circumferential surface 39A is a spherical curved surface concentric with the outer surface of the spherical portion 36. The first inner circumferential surface 39A is a surface facing the outer surface of the spherical portion 36 at a predetermined interval in the radial direction R. Then, the outer surface of the spherical portion 36 and the first inner circumferential surface 39A sandwich a dirt prevention portion 51 of the packing 33 described below in an elastically compressed state.

Note that the shape of the first inner circumferential surface 39A is not limited to the curved surface (spherical surface) described above, and may be, for example, a curved shape other than a spherical surface, or a flat surface as long as the surface extends in a direction in which the diameter of the opening 39 decreases toward the distal end side in the axial direction Z.

The second inner circumferential surface 39B is located on the base end side in the axial direction Z relative to the first inner circumferential surface 39A. The second inner circumferential surface 39B is a cylindrical surface having the same diameter in the axial direction Z. The length of the second inner circumferential surface 39B in the axial direction Z is set in accordance with the intermediate portion 37 of the cover member 31. The second inner circumferential surface 39B is a surface facing the outer surface of the intermediate portion 37 at a predetermined interval in the radial direction R. The outer surface of the intermediate portion 37 and the second inner circumferential surface 39B sandwich a cylindrical portion 52 of the packing 33 described below.

A contact surface 41, first attachment surfaces 42, and a second attachment surface 43 are formed on the inner surface side of the exterior member 32. The contact surface 41, the first attachment surfaces 42, and the second attachment surface 43 are flat surfaces orthogonal to the axial direction Z.

The contact surface 41 is a surface continuous with the second inner circumferential surface 39B. More specifically, on the inner surface of the main wall 32A, the contact surface 41 extends outward in the radial direction R from the base end of the second inner circumferential surface 39B in the axial direction Z. The contact surface 41 is a ring-shaped surface continuous in the circumferential direction of the second inner circumferential surface 39B. The contact surface 41 is a surface in contact with a water stop portion 53 of the packing 33 described below. The contact surface 41 is also a surface facing the flange portion 38 in the axial direction Z with the water stop portion 53 interposed therebetween.

The first attachment surfaces 42 are provided at positions corresponding to the attachment surfaces 25 of the housing main body 22. The first attachment surfaces 42 are surfaces in contact with the attachment surfaces 25 of the housing main body 22 in the axial direction Z. One or both of the through hole 42A and the positioning pin 42B are formed in each first attachment surface 42. The through hole 42A penetrates, in the axial direction Z, a portion of the tubular wall 32B where each first attachment surface 42 is formed.

The positioning pins 42B protrude from the first attachment surfaces 42 toward the base end side in the axial direction Z. When the positioning pins 42B enter the positioning holes 25B, the through holes 42A and the female screw holes 25A communicate with each other (that is, the exterior unit 21 and the housing main body 22 are positioned). The screws 23 passing through the through holes 42A are screwed into the female screw holes 25A, so that the exterior unit 21 is fixed to the housing main body 22. That is, the exterior unit 21 and the housing main body 22 are fastened with the screws 23 extending in the axial direction Z in a state in which the attachment surfaces 25 and the first attachment surfaces 42 orthogonal to the axial direction Z are in contact with each other.

On the inner surface of the main wall 32A, the second attachment surface 43 is formed on the outer side in the radial direction R relative to the contact surface 41. The second attachment surface 43 is located on the base end side in the axial direction Z relative to the contact surface 41. The second attachment surface 43 is continuous with the contact surface 41. Furthermore, the second attachment surface 43 is continuous in the circumferential direction about the central axis CL. The second attachment surface 43 is in contact with the flange portion 38 of the spherical portion 36 in the axial direction Z. The bosses 43A and the positioning pins 43B are formed at the second attachment surface 43 at a plurality of positions separated in the circumferential direction. The bosses 43A protrude from the second attachment surface 43 toward the base end side in the axial direction Z. A female screw hole 43C extending in the axial direction Z is formed at each boss 43A. The positioning pins 43B protrude from the second attachment surface 43 toward the base end side in the axial direction Z at positions different from those of the bosses 43A.

The positioning pins 43B enter the positioning hole 38A and the positioning grooves 38B of the cover member 31, and a positioning hole 34A and positioning grooves 34B of the fixing member 34 described below. Accordingly, the female screw holes 43C of the bosses 43A, the cutouts 38C of the cover member 31, and through holes 34C of the fixing member 34 described below communicate with each other (the cover member 31, the exterior member 32, and the fixing member 34 are positioned). The screws 35 passing through the through holes 34C and the cutouts 38C are screwed into the female screw holes 43C, so that the cover member 31, the exterior member 32, and the fixing member 34 are fixed, and the exterior unit 21 is formed as a unit. The exterior unit 21 is fastened with the screws 35 extending in the axial direction Z in a state where the second attachment surface 43, the flange portion 38, and the fixing member 34 are in contact.

### Configuration of Packing 33

As illustrated in FIGS. 7 to 9, the packing 33 is interposed between the cover member 31 and the exterior member 32. The packing 33 is formed of an elastic member (for example, rubber). The packing 33 is integrally provided with the dirt prevention portion 51, the cylindrical portion 52, and the water stop portion 53.

The dirt prevention portion 51 has a ring outer shape. The dirt prevention portion 51 is located on the distal end side in the axial direction Z. The dirt prevention portion 51 is curved so as to gradually decrease in diameter toward the distal end side in the axial direction Z. In other words, the dirt prevention portion 51 is curved along the outer surface of the spherical portion 36 and the first inner circumferential surface 39A. The dirt prevention portion 51 is sandwiched between the outer surface of the spherical portion 36 and the first inner circumferential surface 39A and elastically compressed. Further, the distal end of the dirt prevention portion 51 is located on the inner surface side (base end side in the axial direction Z) relative to the outer surface of the exterior member 32.

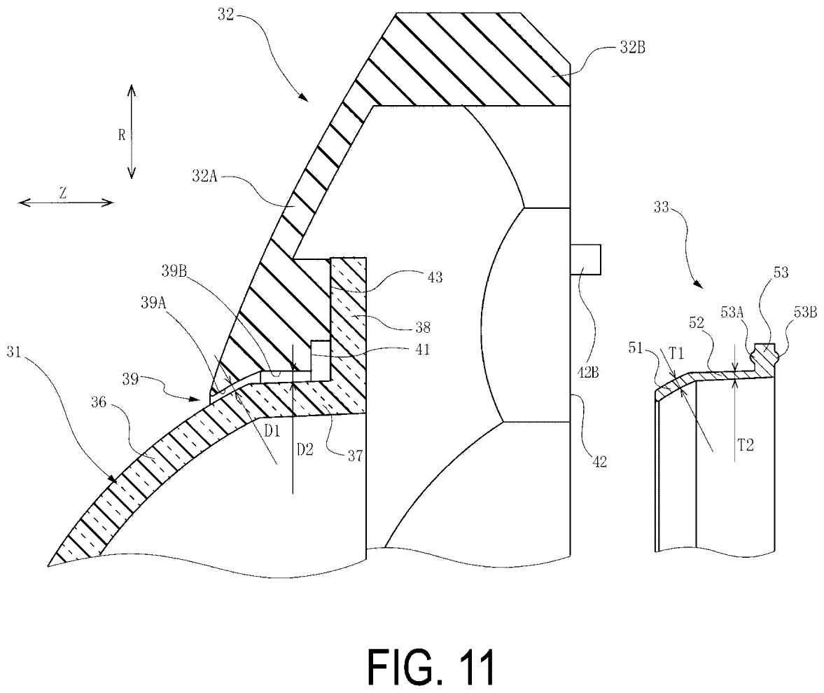

As illustrated in FIG. 11, a thickness dimension (wall thickness) T1 of the dirt prevention portion 51 in a natural state (a state before being elastically compressed) is set to be larger than a clearance D1 between the first inner circumferential surface 39A and the outer surface of the spherical portion 36. Note that although the packing 33 is actually interposed between the cover member 31 and the exterior member 32, FIG. 11 illustrates a state in which the packing 33 is removed from between the cover member 31 and the exterior member 32 for description of a dimensional relationship. As described above, the dirt prevention portion 51 sandwiched between the outer surface of the spherical portion 36 and the first inner circumferential surface 39A is elastically compressed. Therefore, the dirt prevention portion 51 is accommodated in the clearance D1 between the first inner circumferential surface 39A and the outer surface of the spherical portion 36. Note that the thickness dimension Tl is a thickness dimension of the dirt prevention portion 51 in the normal direction. The clearance D1 has a dimension of a clearance between the first inner circumferential surface 39A and the outer surface of the spherical portion 36 in the normal direction.

The cylindrical portion 52 has a cylindrical outer shape extending in the axial direction Z. One end (distal end side) of the cylindrical portion 52 in the axial direction Z is connected to the dirt prevention portion 51, and another end (base end side) of the cylindrical portion 52 in the axial direction Z is connected to the water stop portion 53. That is, the cylindrical portion 52 is a portion located between the dirt prevention portion 51 and the water stop portion 53 and connecting the dirt prevention portion 51 and the water stop portion 53. Further, the length of the cylindrical portion 52 in the axial direction Z is set in accordance with the intermediate portion 37 of the cover member 31. Further, the diameter (inner diameter dimension and outer diameter dimension) of the cylindrical portion 52 is substantially the same in the axial direction Z. Further, in the natural state (the state before being elastically compressed), a thickness dimension (wall thickness) T2 of the cylindrical portion 52 in the radial direction R is set to be smaller than a clearance D2 between the outer circumferential surface of the intermediate portion 37 and the second inner circumferential surface 39B in the radial direction R.

The water stop portion 53 is a flange-shaped portion that protrudes outward in the radial direction R from the base end side of the cylindrical portion 52 in the axial direction Z and that is continuous in the circumferential direction. The water stop portion 53 is a portion elastically compressed in the axial direction Z between the flange portion 38 of the cover member 31 and the inner surface (more specifically, the contact surface 41) of the exterior member 32. Protrusions 53A and 53B are formed at the water stop portion 53.

The protrusion 53A protrudes from the water stop portion 53 toward the contact surface 41 and is continuous in the circumferential direction. The protrusion 53B protrudes from the water stop portion 53 toward the flange portion 38 and is continuous in the circumferential direction. The protrusion 53A and 53B are portions flattened by the contact surface 41 and the flange portion 38 when the flange portion 38 and the second attachment surface 43 are in contact with each other. Note that the water stop portion 53 is only required to include at least one of the protrusion 53A and 53B.

### Configuration of Fixing Member 34

The fixing member 34 is formed in a shape of a ring having a predetermined thickness in the axial direction Z. The fixing member 34 is disposed on a side opposite to the exterior member 32 in the axial direction Z with the flange portion 38 of the cover member 31 interposed therebetween. Further, the fixing member 34 is continuous in the circumferential direction so as to surround the spherical portion 36. Further, the positioning hole 34A, the positioning grooves 34B, and the through holes 34C are formed at different positions of the fixing member 34 in the circumferential direction.

The positioning hole 34A penetrates the fixing member 34 in the axial direction Z at a position that can communicate with the positioning hole 38A of the flange portion 38. The positioning grooves 34B are grooves extending from the outer edge of the fixing member 34 toward the central axis CL at positions that can communicate with the positioning grooves 38B of the flange portion 38. Then, the positioning pins 43B passing through the positioning hole 38A and the positioning grooves 38B enter the positioning hole 34A and the positioning grooves 34B. The through holes 34C penetrate the fixing member 34 in the thickness direction at positions communicating with the cutouts 38C and the female screw holes 43C. Then, the screws 35 passing through the through holes 34C and the cutouts 38C are screwed into the female screw holes 43C.

### Assembly Process of Surveillance Camera 1

In an assembly process of the exterior unit 21, that is, a process of forming the components (31 to 35) as a unit, the packing 33 is first interposed between the cover member 31 and the exterior member 32. Specifically, the dirt prevention portion 51 is interposed between the outer surface of the spherical portion 36 and the first inner circumferential surface 39A, the cylindrical portion 52 is interposed between the outer surface of the intermediate portion 37 and the second inner circumferential surface 39B, and the water stop portion 53 is interposed between the flange portion 38 of the cover member 31 and the contact surface 41 of the exterior member 32.

Further, the positioning pins 43B enter the positioning hole 38A and the positioning grooves 38B of the cover member 31 with the packing 33 interposed between the cover member 31 and the exterior member 32. Thus, the cover member 31 is positioned with respect to the second attachment surface 43 (exterior member 32) in the radial direction R and the circumferential direction. Specifically, the flange portion 38 of the cover member 31 is located on the base end side in the axial direction Z relative to the second attachment surface 43, and the cutouts 38C receive the bosses 43A. Note that, in this state, that is, in a state before the flange portion 38 and the fixing member 34 are fastened with the screws 35, there is a clearance between the second attachment surface 43 and the flange portion 38. In addition, the positioning pins 43B entering the positioning hole 38A and the positioning grooves 38B protrude toward the base end side of the flange portion 38.

Next, the positioning pins 43B passing through the positioning hole 38A and the positioning grooves 38B enter the positioning hole 34A and the positioning grooves 34B of the fixing member 34. Thus, the fixing member 34 is positioned with respect to the second attachment surface 43 in the radial direction R and the circumferential direction. That is, the fixing member 34 is located on the base end side in the axial direction Z relative to the flange portion 38 of the cover member 31. Further, the through holes 34C communicate with the bosses 43A (female screw holes 43C) of the exterior member 32 and the cutouts 38C of the cover member 31.

The packing 33 is interposed between the cover member 31 and the exterior member 32, and the exterior member 32, the cover member 31, and the fixing member 34 are positioned. After that, the screws 35 are screwed into the female screw holes 43C. The fixing member 34 is fastened to the exterior member 32. Thus, the exterior unit 21 is formed as a unit.

The female screw holes 43C, the cutouts 38C, the through holes 34C, and the screws 35 are arranged to extend in the axial direction Z. Thus, by screwing the screws 35 into the female screw holes 43C, the fixing member 34 and the exterior member 32 are moved along the axial direction Z in directions in which these members approach each other. This brings about a state in which the second attachment surface 43 of the exterior member 32 and the flange portion 38 of the cover member 31 are in contact with each other, and further brings about a state in which the flange portion 38 of the cover member 31 and the fixing member 34 are in contact with each other.

Further, the dirt prevention portion 51 of the packing 33 is sandwiched between the outer surface of the spherical portion 36 of the cover member 31 and the first inner circumferential surface 39A of the exterior member 32. The exterior member 32 and the fixing member 34 are fastened with the screws 35, so that the dirt prevention portion 51 is pressed in the axial direction Z from the outer surface of the spherical portion 36 and the first inner circumferential surface 39A. The outer surface of the spherical portion 36 and the first inner circumferential surface 39A are curved surfaces that are curved so as to decrease in diameter toward the distal end side in the axial direction Z. Thus, the dirt prevention portion 51 sandwiched between the outer surface of the spherical portion 36 and the first inner circumferential surface 39A is elastically compressed.

Further, the water stop portion 53 of the packing 33 is sandwiched between the flange portion 38 of the cover member 31 and the contact surface 41 of the exterior member 32. The exterior member 32 and the fixing member 34 are fastened with the screws 35, so that the water stop portion 53 is pressed in the axial direction Z by the flange portion 38 and the contact surface 41. Since the flange portion 38 and the contact surface 41 are arranged orthogonal to the axial direction Z, the water stop portion 53 sandwiched between the flange portion 38 and the contact surface 41 is elastically compressed. Further, when the flange portion 38 and the second attachment surface 43 are in surface contact with each other, the protrusion 53A and 53B are flattened by the contact surface 41 and the flange portion 38. The elastically compressed water stop portion 53 is in close contact with the flange portion 38 and the contact surface 41.

As described above, the thickness dimension (wall thickness) T1 of the dirt prevention portion 51 in the natural state (the state before being elastically compressed) is set to be larger than the clearance D1 between the first inner circumferential surface 39A and the outer surface of the spherical portion 36.

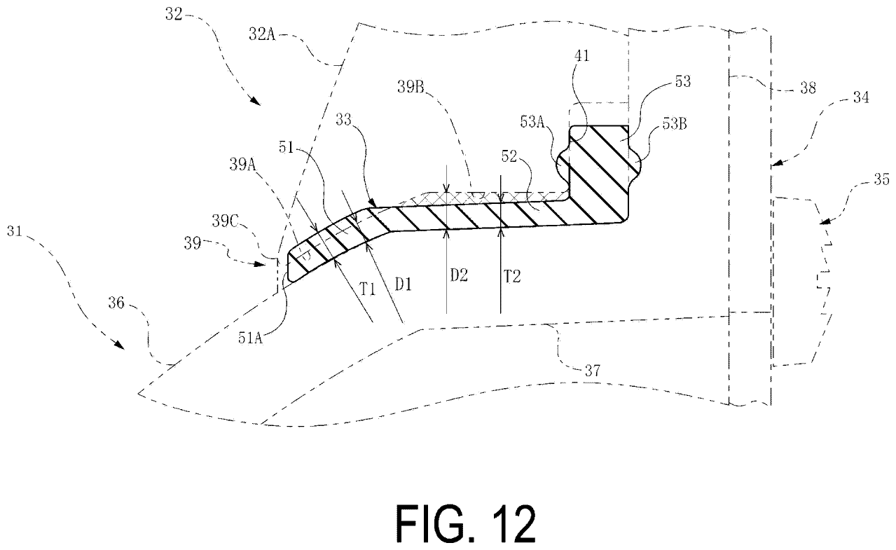

As illustrated in FIG. 12, the dirt prevention portion 51 sandwiched between the first inner circumferential surface 39A and the outer surface of the spherical portion 36 is elastically compressed in the normal direction, and the thickness dimension decreases to less than the thickness dimension T1. Thus, the dirt prevention portion 51 is accommodated in the clearance D1 between the first inner circumferential surface 39A and the outer surface of the spherical portion 36.

On the other hand, when the cylindrical portion 52 is sandwiched between the outer surface of the intermediate portion 37 and the second inner circumferential surface 39B, the thickness of the cylindrical portion 52 increases in the radial direction R from the thickness dimension T2 in the natural state (the state before being elastically compressed) (an increased portion indicated by hatching). This is because a part of the dirt prevention portion 51 elastically compressed as described above moves toward the cylindrical portion 52. In addition, the cylindrical portion 52 is pressed in the axial direction Z and thus may elastically expand in the radial direction R orthogonal to the axial direction Z. As described above, the thickness dimension T2 of the cylindrical portion 52 in the natural state is set to be smaller than the clearance D2 in the radial direction R between the outer circumferential surface of the intermediate portion 37 and the second inner circumferential surface 39B. Therefore, even when the thickness dimension T2 of the cylindrical portion 52 increases, the cylindrical portion 52 is accommodated in the space defined by the outer circumferential surface of the intermediate portion 37 and the second inner circumferential surface 39B.

In addition, the position of a distal end 51A of the dirt prevention portion 51 in the axial direction Z is located on the inner surface side (the base end side in the axial direction Z) relative to the outer surface of the exterior member 32. Specifically, the position of the distal end 51A of the dirt prevention portion 51 is located on the base end side in the axial direction Z relative to a distal end 39C of the first inner circumferential surface 39A.

As described above, the exterior unit 21 obtained by forming the components (31 to 35) as a unit is fastened to the housing main body 22. First, the positioning pins 42B of the exterior member 32 enter the positioning holes 25B of the housing main body 22. Thus, the exterior unit 21 and the housing main body 22 are positioned. Then, the screws 23 passing through the through holes 42A are screwed into the female screw holes 25A. Thus, the exterior unit 21 and the housing main body 22 are fastened with the screws 23. By fastening the exterior unit 21 and the housing main body 22, the cover member 31 is attached to the housing main body 22 so that the spherical portion 36 covers the imaging unit 12.

### Operational Effect of Embodiment

According to the above-described embodiment, the ring-shaped dirt prevention portion 51 provided at the packing 33 is sandwiched between the outer surface of the spherical portion 36 and the opening 39 (inner circumferential surface) of the exterior member 32 and elastically compressed. Thus, the space between the spherical portion 36 and the exterior member 32 is filled with the dirt prevention portion 51, and it is possible to prevent foreign matter such as dirt from entering. This can improve cleanability of the surveillance camera 1 and maintain a sanitary appearance. The inner circumferential surface of the exterior member 32 includes the first inner circumferential surface 39A extending toward the outer surface side of the exterior member 32 in a direction in which the diameter of the opening 39 decreases, and the dirt prevention portion 51 is sandwiched between the outer surface of the spherical portion 36 and the first inner circumferential surface 39A and elastically compressed. This further makes the clearance between the spherical portion 36 and the exterior member 32 small. That is, since the clearance is easily filled with the dirt prevention portion 51, it is possible to further prevent foreign matter from entering.

In addition, since the dirt prevention portion 51 is curved along the outer surface of the spherical portion 36 and the first inner circumferential surface 39A, the dirt prevention portion 51 easily follows the outer surface of the spherical portion 36 and the first inner circumferential surface 39A, and the clearance between the spherical portion 36 and the exterior member 32 is further easily filled. In addition, since the distal end of the dirt prevention portion 51 is located on the inner surface side relative to the outer surface of the exterior member 32, the dirt prevention portion 51 does not protrude from the outer surface of the exterior member 32 even when the dimension of the dirt prevention portion 51 in the axial direction Z increases due to the elastic compression or deterioration with time. Thus, the dirt prevention portion 51 can be prevented from being exposed to the outside or damaged by being caught by a cleaning tool, a finger of a person, or the like.

In addition, since the packing 33 is provided with the ring-shaped water stop portion 53 elastically compressed between the flange portion 38 of the cover member 31 and the inner surface of the exterior member 32, as well as the dirt prevention portion 51, a water stop effect of preventing water from entering the inside of the housing 11 and a dirt prevention effect of improving the cleanability of the surveillance camera 1 can be achieved by one component. Thus, it is possible to improve the cleanability and suppress a cost increase without increasing the number of parts. In addition, since the packing 33 includes the protrusion 53A and 53B that protrude toward at least one of the flange portion 38 and the inner surface of the exterior member 32 and that are continuous in the circumferential direction, the protrusion 53A and 53B are flattened to be in close contact with the exterior member 32 and the flange portion 38, and thus it is possible to improve the water stop effect.

Further, since the water stop portion 53 is elastically compressed between the flange portion 38 and the inner surface of the exterior member 32 by fastening the ring-shaped fixing member 34 to the inner surface of the exterior member 32 with the screws 35, the water stop portion 53 is reliably in close contact with the exterior member 32 and the flange portion 38. Further, the water stop portion 53 is not ununiformly in close contact with the exterior member 32 and the flange portion 38, and the water stop effect can be enhanced. In addition, since the water stop portion 53 is pressed by the fixing member 34 due to the screw fastening between the fixing member 34 and the exterior member 32, the water stop portion 53 can be pressed with a uniform force and be in close contact with the exterior member 32 and the flange portion 38.

In addition, the packing 33 includes the cylindrical portion 52 extending in the axial direction Z, and the dirt prevention portion 51 and the water stop portion 53 are separated from each other in the axial direction Z. In addition, the cover member 31 includes the cylindrical intermediate portion 37 extending in the axial direction Z, and the end portion of the spherical portion 36 and the flange portion 38 are separated from each other in the axial direction Z. These are effective for obtaining a space for fastening in the axial direction Z (a space for screwing the screws 35 in the present embodiment). In order to obtain the space for fastening in the axial direction Z, the fixing member 34 needs to be located on the base end side as much as possible relative to the outer surface of the exterior member 32. Therefore, in the present embodiment, the flange portion 38 and the water stop portion 53 are separated from the spherical portion 36 and the dirt prevention portion 51. As a result, the fixing member 34 can be located on the base end side and the space for fastening can be obtained. By obtaining the space for fastening, the dirt prevention portion 51 and the water stop portion 53 can be sufficiently pressed by the fixing member 34.

In addition, since the cylindrical portion 52 of the packing 33 is accommodated in the space defined by the outer circumferential surface of the intermediate portion 37 of the cover member 31 and the second inner circumferential surface 39B of the exterior member 32, it is not necessary to increase the dimension of the packing 33 in the radial direction R, and it is possible to prevent upsizing of the surveillance camera 1.

Since the thickness dimension of the cylindrical portion 52 in the natural state is smaller than the clearance between the outer circumferential surface of the intermediate portion 37 and the second inner circumferential surface 39B in the radial direction R, the cylindrical portion 52 is accommodated between the outer circumferential surface of the intermediate portion 37 and the second inner circumferential surface 39B even when the thickness dimension T2 of the cylindrical portion 52 increases due to the elastic compression of the dirt prevention portion 51.

The above-described embodiment is an example for describing the present disclosure, and there is no intention of limiting the scope of the present disclosure only to the embodiment. Those skilled in the art can appropriately change the present disclosure without departing from the spirit of the present disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. An imaging apparatus comprising:
an imaging unit configured to image a subject;
a cover member including a spherical portion that is light transmissive, the spherical portion covering the imaging unit;
an exterior member to which the cover member is fixed on an inner surface side and in which an opening through which the spherical portion protrudes toward an outer surface side is formed; and
a packing interposed between the cover member and the exterior member, wherein
the exterior member includes an inner circumferential surface forming the opening, the inner circumferential surface being at a predetermined interval from an outer surface of the spherical portion, and
the packing includes a dirt prevention portion sandwiched between the outer surface of the spherical portion and the inner circumferential surface of the exterior member and elastically compressed.

2. The imaging apparatus according to claim 1, wherein
the inner circumferential surface includes a first inner circumferential surface extending toward the outer surface side of the exterior member in a direction in which a diameter of the opening decreases, and
the dirt prevention portion is sandwiched between the outer surface of the spherical portion and the first inner circumferential surface and elastically compressed.

3. The imaging apparatus according to claim 2, wherein
the dirt prevention portion is curved along the outer surface of the spherical portion and the first inner circumferential surface.

4. The imaging apparatus according to claim 3, wherein
a distal end of the dirt prevention portion is located on the inner surface side relative to an outer surface of the exterior member.

5. The imaging apparatus according to claim 2, wherein
the cover member includes a flange portion protruding outward in a radial direction relative to the spherical portion, the flange portion being continuous in a circumferential direction, and
the packing includes a water stop portion elastically compressed between the flange portion and an inner surface of the exterior member.

6. The imaging apparatus according to claim 5, wherein
the water stop portion includes a protrusion protruding toward at least one of the flange portion or the inner surface of the exterior member, the protrusion being continuous in the circumferential direction.

7. The imaging apparatus according to claim 5, comprising:
a fixing member located on a side opposite to the exterior member with the flange portion interposed between the exterior member and the fixing member, wherein
the fixing member is fastened to the inner surface of the exterior member with a screw, and thus the water stop portion is elastically compressed between the flange portion and the inner surface of the exterior member.

8. The imaging apparatus according to claim 7, wherein
the packing includes a cylindrical portion connecting the dirt prevention portion and the water stop portion and extending in an axial direction.

9. The imaging apparatus according to claim 8, wherein
the cover member includes an intermediate portion having a cylindrical shape, the intermediate portion connecting an end portion of the spherical portion and the flange portion and extending in the axial direction,
the inner circumferential surface includes a second inner circumferential surface having a cylindrical shape, the second inner circumferential surface extending from the first inner circumferential surface toward the inner surface side of the exterior member, and
the cylindrical portion is accommodated in a space defined by an outer circumferential surface of the intermediate portion and the second inner circumferential surface.

10. The imaging apparatus according to claim 9, wherein
a thickness dimension of the cylindrical portion in a natural state is smaller than a clearance between the outer circumferential surface of the intermediate portion and the second inner circumferential surface in the radial direction.
